(19) United States
(12) Patent Application Publication
(10) Pub. No.: US 2009/0028145 A1
(43) Pub. Date: Jan. 29, 2009

(54) TELEPHONE EXCHANGE APPARATUS AND CONTROL METHOD FOR USE IN THE APPARATUS

(75) Inventors: Fumio Shibasaki, Sagamihara-shi (JP); Takanori Kaji, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/171,976

(22) Filed: Jul. 11, 2008

(30) Foreign Application Priority Data
Jul. 26, 2007 (JP) 2007-194895

(51) Int. Cl. H04L 12/56

(52) U.S. Cl. 370/389

(57) ABSTRACT

According to one embodiment, a telephone exchange apparatus includes a memory stores a management table in which a connecting destination ID specifying a communication partner on the packet communication network and a first waiting time from a time of signal transmission to the communication partner up to a time of an arrival of a response signal are associated with each other, a monitoring unit refers to the management table and monitors presence or absence of the response signal from the communication partner within the first waiting time corresponding to connection ID of the communication partner based on the reference result, and a controller stops transmission of a signal necessary for communication establishment to the connecting destination ID in the management table and updates first waiting time corresponding to the connecting destination ID in the management table into second waiting time shorter than the first waiting time.

### CROSS-REFERENCE TO RELATED APPLICATIONS

This application is based upon and claims the benefit of priority from Japanese Patent Application No. 2007-194895, filed Jul. 26, 2007, the entire contents of which are incorporated herein by reference.

### BACKGROUND

1. Field

One embodiment of the present invention relates to an Internet Protocol (IP) telephone system. More specifically, the present invention relates to a telephone exchange apparatus configure to perform voice communication among a plurality of communication terminals and an IP network through an interface unit, and relates to a control method for use in the telephone exchange apparatus.

2. Description of the Related Art

In recent years, an IP telephone system which transmits and receives in real time images and voice as packet data interactively has become widely used. The IP telephone system may make extension communication and outside-line origination or termination among main apparatuses via the IP network as well as may make inter-extension communication and outside-line origination or termination for each main apparatus to be connected to the IP network.

Meanwhile, the forgoing IP telephone system, there is every possibility of occurrence of a failure in the IP network or in a server of a communication partner. A method for making a client shorten a validity period of a domain name system (DNS) when a failure occurs in a system which synchronizes files with each other in two file servers is proposed (e.g., Jpn. Pat. Appln. KOKAI Publication No. 2005-250626).

However, as regards countermeasures for the occurrence of the failure in the IP network or in the communication partner on the IP network has been in an examination stage and has not been actualized yet.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting a configuration of an IP network communication system of the first embodiment regarding the invention;

FIG. 2 is a view depicting an example of data showing correspondence relationships among local area network (LAN) interface units, opposite destination IP addresses (connecting destination IDs), watch timer values, last response reception times and failure states of the first embodiment;

FIG. 3 is a view depicting an example of data showing correspondence relationships among timer values to be set in a timer watch unit and timer types of the first embodiment;

FIG. 4 is a view depicting an example of a coefficient for reducing a timer value when a failure occurs of the first embodiment;

FIG. 5 is a sequence view depicting communication operations among a call control unit, a LAN interface unit and a main apparatus according to an originating operation by an extension terminal of the first embodiment;

FIG. 6 is a flowchart depicting a control processing procedure of a call control unit in the originating operation of the first embodiment;

FIG. 7 is a flowchart depicting a control processing procedure of a call control unit in detecting a failure of the first embodiment;

FIG. 8 is a sequence view depicting communication operations among a call control unit, a LAN interface unit and a main apparatus, a LAN interface unit and a main apparatus according to an originating operation by an extension terminal to a failed opposite destination of the second embodiment;

FIG. 9 is a flowchart depicting a control processing procedure of a call control unit of the second embodiment; and

FIG. 10 is a flowchart depicting a control processing procedure of a call control unit in a modified example of the second embodiment.

### DETAILED DESCRIPTION

Various embodiments according to the invention will be described hereinafter with reference to the accompanying drawings. In general, according to one embodiment of the invention, a telephone exchange apparatus configured to house a plurality of communication terminals and connect a packet communication network to transmit a communication packet, comprising: a memory which stores a management table in which a connecting destination ID specifying a communication partner on the packet communication network and a first waiting time from a time of signal transmission to the communication partner up to a time of an arrival of a response signal are associated with each other; a monitoring unit which refers to the management table in occurrence of a communication establishment request to the communication partner of the packet communication network and monitors presence or absence of the response signal from the communication partner within the first waiting time corresponding to connection ID of the communication partner based on a reference result of the management table; and a controller which stops transmission of a signal necessary for communication establishment to the connecting destination ID in the management table and updates first waiting time corresponding to the connecting destination ID in the management table into second waiting time shorter than the first waiting time when the monitoring unit determines that the response signal is not replied within the first waiting time.

### FIRST EMBODIMENT

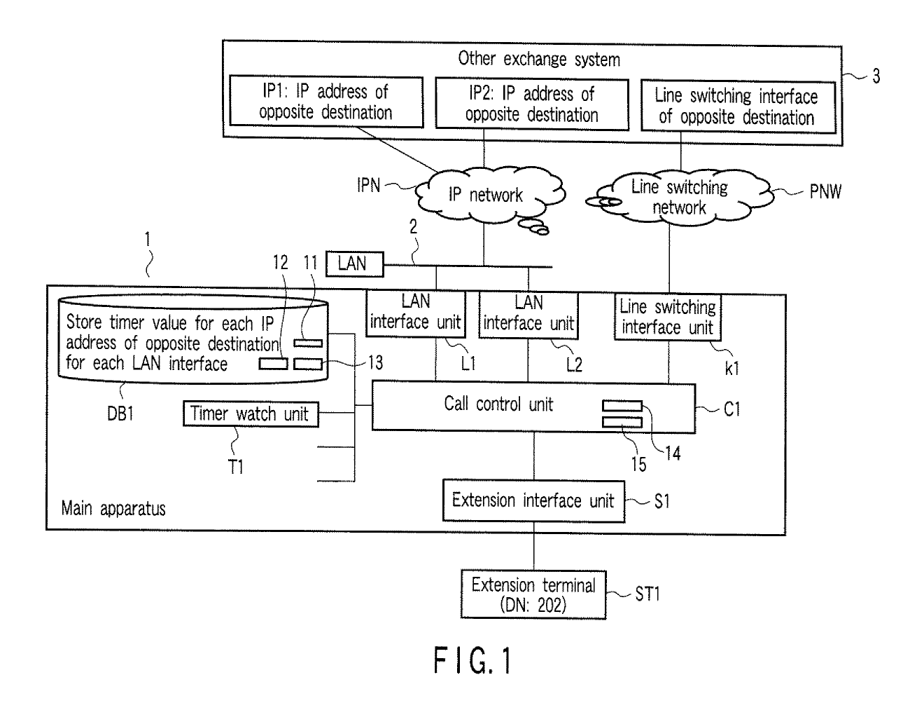

FIG. 1 shows a block diagram depicting a configuration of an IP network communication system of the first embodiment regarding the invention. The numerical FIG. 1 designates a main apparatus.

An IP network IPN is connected to the main apparatus 1 via a LAN 2. A line switching network PNW is connected to the main apparatus 1. A plurality of main apparatuses are connected to the IP network IPN and the line switching network PNW. To simplify the description, FIG. 1 shows only one main apparatus 3.

The main apparatus 1 includes an extension interface unit S1, LAN interface units L1, L2, a line switching interface unit K1, a call control unit C1, a database DB1 and a timer watch unit T1.

The extension interface unit S1 houses an extension terminal ST1. The extension interface unit S1 performs an interface operation such as origination and termination processing for the extension terminal ST1. The extension interface unit S1 performs transmission and reception of various control information on the interface operations to the extension terminal ST1 to and from the call control unit C1. An extension number (DN: 202) is assigned to the extension terminal ST1.

The LAN interface units L1, L2 performs interface processing to and from the LAN 2.

The line switching interface unit K1 conducts interface processing to and from the line switching network PNW.

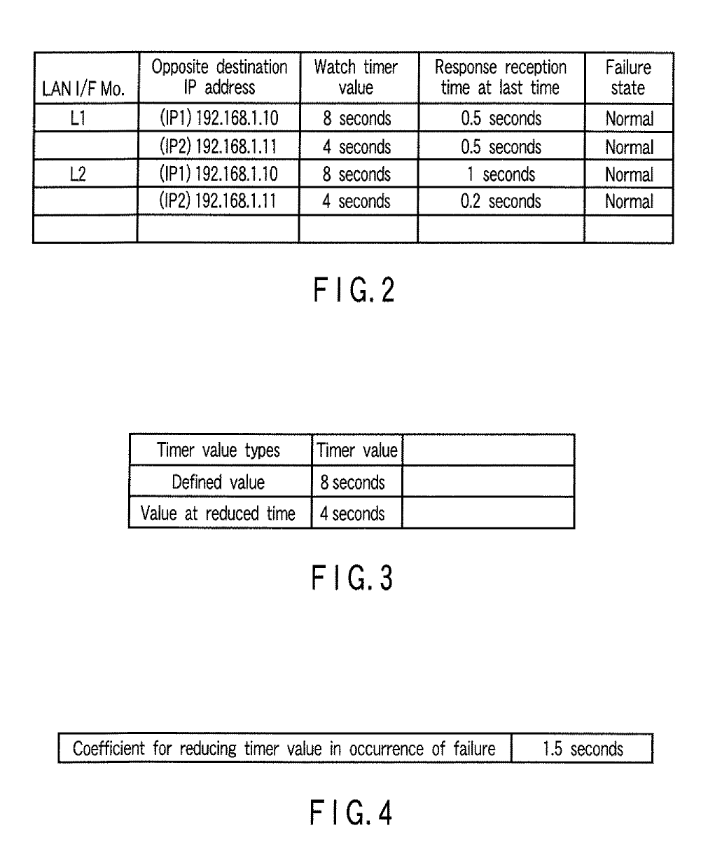

The database DB1 includes tables 11, 12 and 13. The table 11 stores data showing correspondence relationships among the LAN interface units L1, L2, opposite destination IP addresses (connecting destination IDs), watch timer values, last response reception times and failure states, as shown in FIG. 2.

The table 12 stores data showing correspondence relationships among the timer values to be set in the timer watch unit T1 with timer value types, as shown in FIG. 3.

The table 13 stores a coefficient for reducing timer value in occurrence of a failure, as shown in FIG. 4.

Meanwhile, the call control unit C1 includes a failure monitoring unit 14 and a failure correspondence unit 15 in addition to a control function for actualizing operations as the main apparatus 1. The failure monitoring unit 14 refers to the table 11 in requesting communication establishment to the main apparatus 3 on the IP network IPN, reads a watch timer value (8 seconds) to set it in the timer watch unit T1 and transmit a call control message to the opposite destination, and watches whether or not a response message is replied before time-out by means of the timer watch unit T1.

The failure correspondence unit 15 stops the transmission of the call control message to the opposite destination if the response message is not replied before the time-out by the timer watch unit T1, starts transmission of call control messages to another IP address (192. 168. 1. 11) registered in the table 11, and updates the watch timer value corresponding to an IP address (192. 168. 1. 10) of the opposite destination in the table 11 from ‘8 seconds’ to ‘4 seconds’.

Next, operations of the IP network communication system configured as mentioned above will be described.

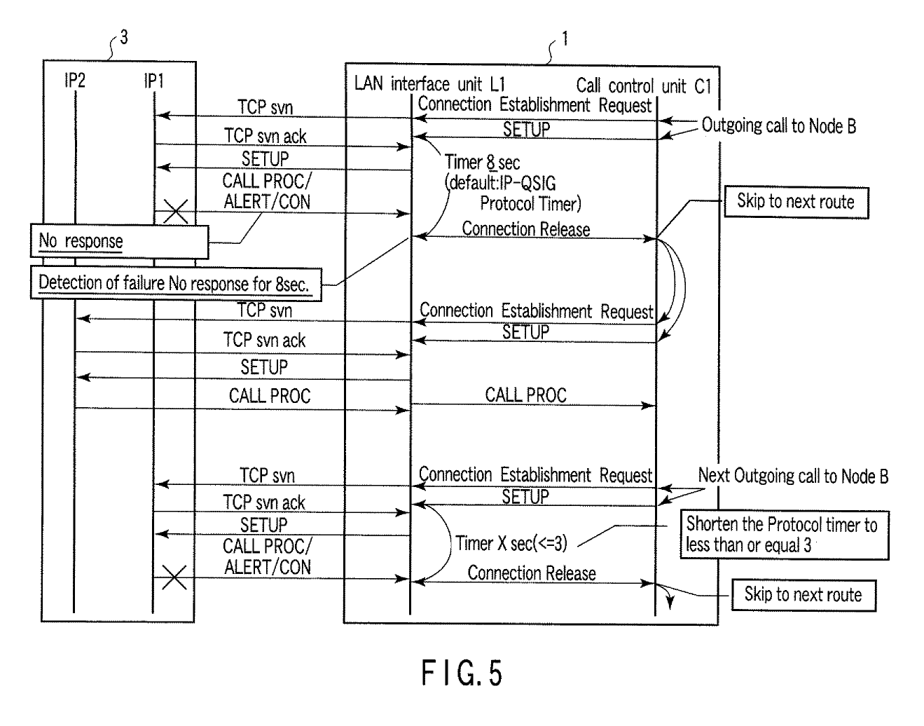

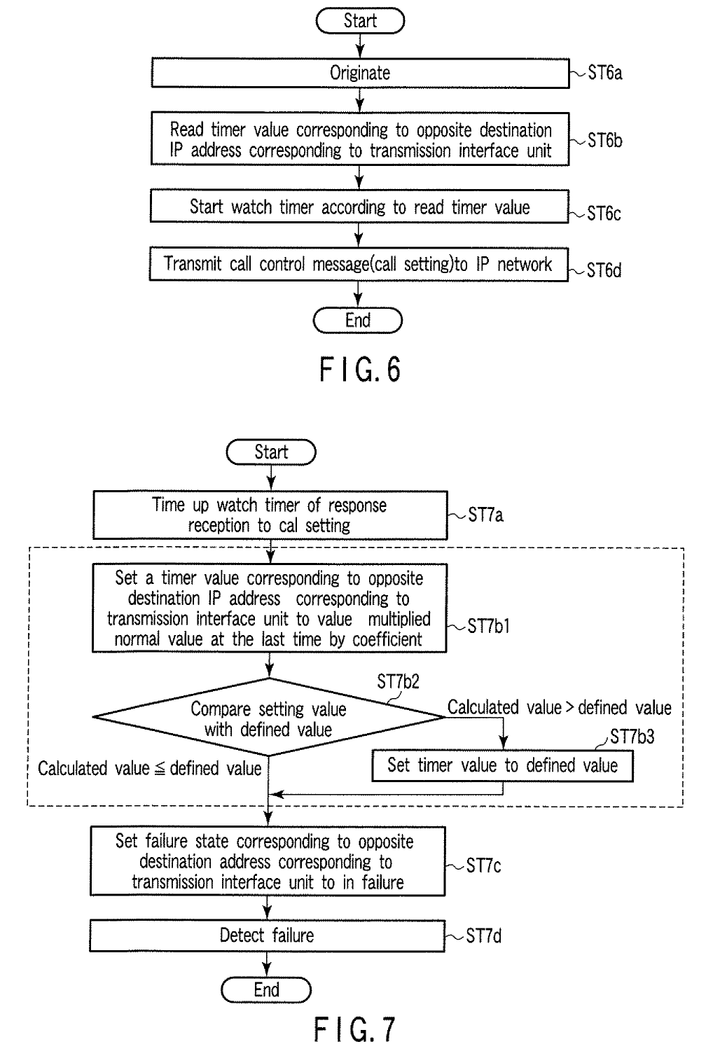

FIG. 5 shows a flowchart depicting communication operations among the call control unit C1, the LAN interface unit L1 and the main apparatus 3 according to an originating operation. FIG. 6 is a flowchart depicting a control processing procedure of the call control unit C1 in the originating operation.

It is assumed that the originating operation to the main operation via the IP network IPN by the extension terminal ST1 housed in the main apparatus 1. Then, the call control unit C1 shifts from block ST6a to block ST6b, reads a watch timer value ‘8 seconds’ corresponding to the opposite destination IP address (192. 168. 1. 10) from dial information input by means of the extension terminal ST1 in block ST6b by referring to the table 11, and sets the timer value ‘8 seconds’ in the timer watch unit T1 to start the unit T1 (block ST6c). The call control unit C1 executes to transmit a call control message to the IP network IPN (block ST6d). At this time, the LAN interface unit L1 transmits a Transmission Control Protocol (TCP) connection establishment request toward the main apparatus 3. The call control unit C1 determines whether or not a TCP connection establishment response is replied before the time-out by means of the timer watch unit T1.

FIG. 7 shows a flowchart depicting a control processing procedure of the call control unit C1 in detecting any failure.

If any response message from the opposite destination does not arrive before the time-out by means of the timer watch unit T1, the call control unit C1 makes a shift from block ST7a to block ST7b1, calculates a value ‘0.25 seconds’ in which the last response reception time ‘0.5 seconds’ is multiplied by a coefficient ‘1.5 seconds’ in the table 13. The call control unit C1 compares the value ‘0.25 seconds’ with defined values in the table 12 (block ST7b2), and since the vale ‘0.25 seconds’ does not exceed any defined value, the call control unit C1 updates the failure state corresponding to the opposite destination IP address (192. 168. 1. 10) from ‘normal’ into ‘in failure’ (block ST7c).

In block ST7b2, if the value ‘0.25 seconds’ exceeds the defined values, the call control unit C1 sets the watch timer value corresponding to the opposite destination IP address (192. 168. 1. 10) in the table 11 to the defined value (block ST7b3).

The call control unit C1 then stops the transmission of the call control message to the opposite destination IP address (192. 168. 1. 10) and starts the call control message to another opposite destination IP address (192. 168. 1. 11) (block ST7d).

After this, when an origination request is issued to the opposite destination 19 address (192. 168. 1. 10), the call control unit C1 watches whether or not a response message from the opposite destination arrives before time-out ‘0.25 seconds’ by the timer watch unit T1, and if the response message does not arrive, the call control unit C1 can immediately shift to the transmission of the call control message to the next opposite destination (192. 168. 1. 11).

As given above, in the first embodiment, the main apparatus 1 stores the table 11 in which the IP address specifying the opposite destination on the IP network IPN is associated with the watch time value from the time of signal transmission to the opposite destination up to the time until the response message is replied and manages the table 11. The call control unit C1 determines the presence or absence of the response message from the opposite destination before the time-out by setting the watch timer value corresponding-timer value with reference to the table 11 based on the IP address of the opposite destination in requesting the communication establishment to the opposite destination on the IP network IPN. If the time is up and any response message is not replied, the call control unit C1 determines that a failure has occurred, shifts to the transmission processing of the call control message for an IP address of the next candidate and updates the watch timer values in the table 11 into timer values reduced for the occurrence of the failure.

Accordingly, as regards the opposite destination in which a failure has been detected once in originating an IP trunk, the origination becomes able without any time lag in a case in which the failure of the opposite destination has been recovered for originating afterward, and even if the failure has not been recovered yet, the IP network communication system can recognize the failure earlier than usual time and cope with the countermeasures quickly in the occurrence of the failure.

### SECOND EMBODIMENT

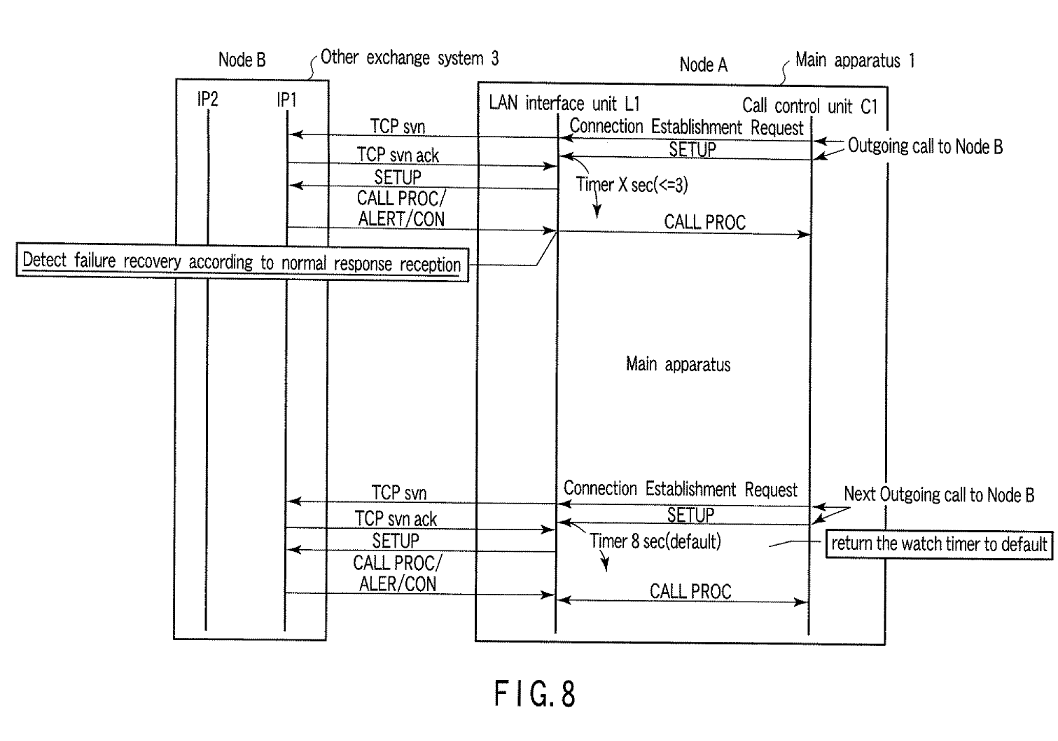

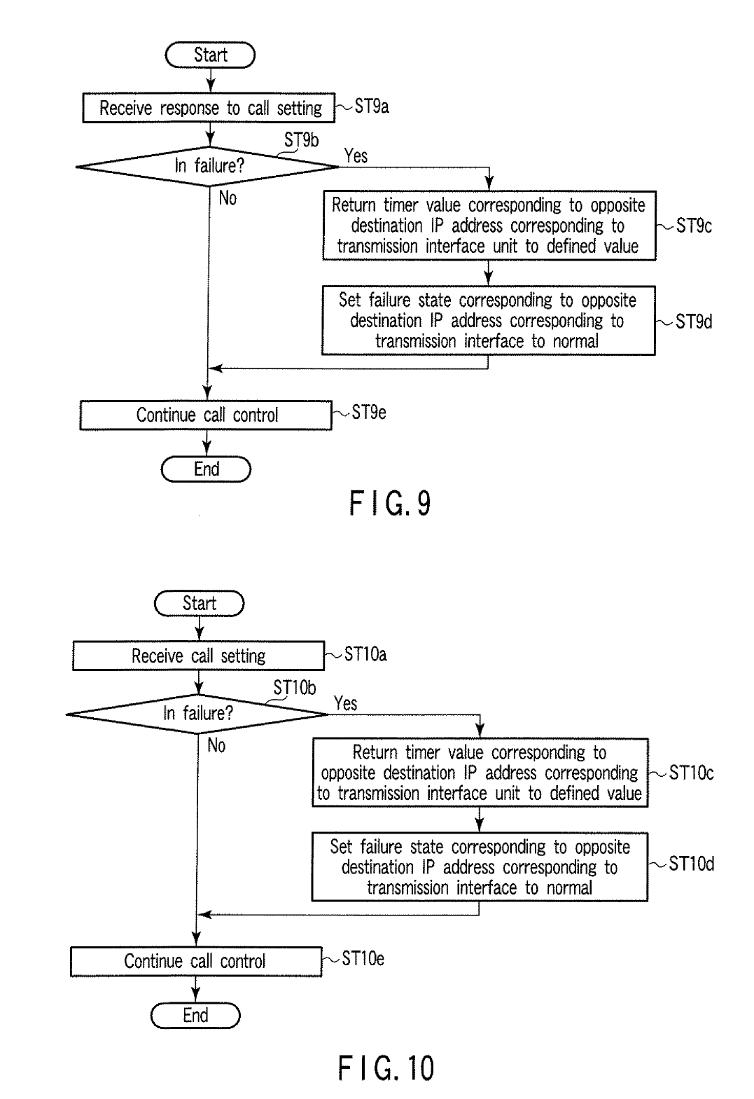

FIG. 8 shows a sequence view depicting communication operations among the call control unit C1, the LAN interface unit L1 and the main device 3 according to the originating operation for the failed opposite destination of the second embodiment regarding the invention. FIG. 9 is a flowchart depicting the control processing procedure of the call control unit C1.

It is assumed that the extension terminal ST1 housed in the main apparatus 1 has performed the originating operation to the main apparatus 3 via the IP network IPN. The call control unit C1 then reads the watch timer value ‘0.25 seconds’ corresponding to the opposite destination IP address (192. 168. 1. 10) with reference to the table 11 from the dial information input from the extension terminal ST1, sets the watch timer value in the timer watch unit T1 to start the timer watch unit T1. The call control unit C1 executes the transmission of the call control message to the IP network IPN.

At this moment, the LAN interface unit L1 transmits the TCP connection establishment request toward the main apparatus 3. The call control unit C1 determines whether or not the TCP connection establishment response is replied from the opposite destination by the time-out through the timer watch unit T1.

If the TCP connection establishment response has been replied from the opposite destination, the call control unit C1 moves from block ST9a to block ST9b to refer the table 11, and determines whether or not the failure state corresponding to the opposite destination IP address (192. 168. 1. 10) is ‘in failure’.

In the case of ‘in failure’, the call control unit C1 returns the watch timer value corresponding to the opposite destination IP address (192. 168. 1. 10) in the table 11 from ‘0.25 seconds’ to the original defined value ‘8 seconds’ (block ST9c), updates the failure state from ‘in failure’ into ‘normal’ (block ST9d) and shifts to the call control continuous processing (block ST9e).

Conversely, in the case of not being ‘in failure’, the call control unit C1 shifts to block ST9e as it is.

As mentioned above, according to the second embodiment, in the main apparatus 1, in the case in which the failure in the previously failed opposite destination is a temporary failure and the temporary failure has been recovered already, or in the case in which maintenance, etc., has been performed to the opposite destination and the failure state has returned to the normal state, the main apparatus 1 returns the watch timer value of the opposite destination in the table 11 to the original defined value without waiting for a manual update operation and also may update the failure state from ‘in failure’ into ‘normal ’.

While the second embodiment has described the case in which the response message is replied during time-out by the timer watch unit T1 to the previously failed opposite destination, in the case, for example, in which an origination request has arrived from the previously failed opposite destination, the call control unit C1 executes the control processing shown in FIG. 10.

That is, the call control unit C1 shifts from block ST10a to block ST10b to refer the table 11 and determines whether or not the failure state corresponding to the opposite destination IP address (192. 168. 1. 10) is ‘in failure’.

If the sate is in ‘in failure’, the call control unit C1 returns the watch timer value corresponding to the opposite destination IP address (192. 168. 1. 10) in the table 11 from ‘0.25 seconds’ to the original defined value ‘8 seconds’ (block ST10c), updates the failure state from ‘in failure’ into ‘normal’ (block ST10d), and shifts to call control continuation processing (block ST10e).

### OTHER EMBODIMENT

The invention is not limited to the aforementioned embodiments. While each of the aforementioned embodiments has described the example that the main apparatus transmits the TCP connection establishment request to the opposite destination, and determines whether or not the TCP connection establishment response arrives from the opposite destination, a communication establishment request other the TCP connection establishment request may be transmitted.

While each of the aforementioned embodiments has described the IP network as an example, a packet network other than IP network can be used.

Other than this, the type and configuration of the IP telephone system, the configuration of the main apparatus, the type of the extension terminal such as a communication terminal, storage content in each database, the failure detection control procedure of the opposite destination and failure correspondence control procedure may be embodied in various forms without departing from the spirit or scope of the general inventive concept of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone exchange apparatus configured to house a plurality of communication terminals and connect a packet communication network to transmit a communication packet, comprising:
a memory which stores a management table in which a connecting destination ID specifying a communication partner on the packet communication network and a first waiting time from a time of signal transmission to the communication partner up to a time of an arrival of a response signal are associated with each other;
a monitoring unit which refers to the management table in occurrence of a communication establishment request to the communication partner of the packet communication network, and monitors presence or absence of the response signal from the communication partner within the first waiting time corresponding to connection ID of the communication partner based on a reference result of the management table; and
a controller which stops transmission of a signal necessary for communication establishment to the connecting destination ID in the management table, and updates first waiting time corresponding to the connecting destination ID in the management table into second waiting time shorter than the first waiting time, when the monitoring unit determines that the response signal is not replied within the first waiting time.

2. The apparatus according to claim 1, wherein
the memory stores first and second connecting destinations IDs differing from each other to the communication partners in the management table,
the monitoring unit monitors presence and absence of response signal from the communication partner within the first waiting times corresponding to the first connecting destination ID;
the controller stops the transmission of the signal necessary for communication establishment to the first connecting destination ID, starts transmission of a signal necessary for communication establishment to the second connecting destination ID, and updates the first waiting time corresponding to the first connecting destination ID in the management table into the second waiting time, when it is determined that the response signal is not replied within the first waiting time.

3. The apparatus according to claim 1, wherein:
when the monitoring unit determines that the response signal is replied within the second waiting time,
the controller returns the second waiting time corresponding to the connecting destination ID in the management table to the first waiting time.

4. The apparatus according to claim 1, wherein the monitoring unit determines presence of absence of a Transmission Control Protocol (TCP) connection establishment response from the communication partner for a TCP connection establishment request.

5. The apparatus according to claim 1, wherein the memory stores a management table in which an interface to connect the apparatus to the packet communication network, the connecting destination ID and the first waiting time are associated with each other.

6. The apparatus according to claim 1, wherein the second waiting time is a value in which a time until last normal response signal reception is multiplied by a prescribed coefficient.

7. A control method for use in a telephone exchange apparatus configured to house a plurality of communication terminals and connect a packet communication network to transmit a communication packet, comprising:
storing a management table, in which connecting destination ID specifying a communication partner on the packet communication network and a first waiting time from a times of signal transmission to the communication partner up to a time of an arrival of a response signal are associated with each other, in a memory;
referring to the management table in occurrence of a communication establishment request to the communication partner of the packet communication network;
monitoring presence or absence of the response signal from the communication partner within the first waiting time corresponding to connection ID of the communication partner based on a reference result of the management table; and
stopping transmission of a signal necessary for communication establishment to the connecting destination ID in the management table, and updating the first waiting time corresponding to the connecting destination ID in the management table into second waiting times shorter than the first waiting time, when the watch unit determines that the response signal is not replied within the first waiting time.
